(19) United States
(12) Patent Application Publication
(10) Pub. No.: US 2019/0299812 A1
(43) Pub. Date: Oct. 3, 2019

(54) ELECTRIC VEHICLE, HEAT-DISSIPATING DEVICE ADAPTED TO COOL ELECTRIC VEHICLE, AND METHOD FOR DISSIPATING HEAT FROM ELECTRIC VEHICLE

(71) Applicant: Graduate School at Shenzhen, Tsinghua University, Shenzhen (CN)

(72) Inventors: HONG-DA DU, Shenzhen (CN); ZHEN-WEN JIANG, SHENZHEN (CN); WEI CHEN, Shenzhen (CN); LIN GAN, Shenzhen (CN); JIA LI, Shenzhen (CN); XIN-WEI ZHENG, Shenzhen (CN); CHENG-JUN XU, Shenzhen (CN); XIAO-DONG CHU, Shenzhen (CN); YOU-WEI YAO, Shenzhen (CN); BAO-HUA LI, Shenzhen (CN); QUAN-HONG YANG, Shenzhen (CN); YAN-BING HE, Shenzhen (CN); FEI-YU KANG, Shenzhen (CN)

(21) Appl. No.: 16/416,623

(22) Filed: May 20, 2019

Related U.S. Application Data
(63) Continuation-in-part of application No. PCT/CN2017/086190, filed on May 26, 2017.

(30) Foreign Application Priority Data
Jan. 19, 2017 (CN) 201710044631.7

(51) Int. Cl. B60L 58/26; H01M 10/656; H01M 10/625; H01M 6/50

(52) U.S. Cl. CPC B60L 58/26; H01M 10/656; B60W 30/1843; H01M 6/5038; H01M 10/625

(57) ABSTRACT

A heat-dissipating device configured to cool the battery pack of an electric vehicle includes a coolant circulating pump and a tank. The coolant circulating pump is configured to engage with the one or more heat dissipation pipes of the electric vehicle and communicate with the one or more heat dissipation pipes. The tank is configured to contain coolant which includes phase change material. When cooling is required, for example during battery recharging, the coolant circulating pump is configured to inject the coolant in the tank into the one or more heat dissipation pipes via the coolant inlet, drive the coolant to flow in the one or more heat dissipation pipes, and take the coolant out from the one or more heat dissipation pipes via the coolant outlet to the exterior. A related electric vehicle and a related heat dissipation method are also provided.

### FIELD

The subject matter herein generally relates to cooling of batteries.

### BACKGROUND

Electric vehicles employ electric battery as a power source to drive the electric vehicle, thus fossil fuels are not consumed, and the greenhouse gas emission can be reduced to 20% relative to fuel vehicles. The lithium ion battery has high energy density, high average output voltage, and low rate of self-discharge. However, large current outflow, compact nature of the battery pack, and energy released charging and discharging of the battery pack can cause the temperature of the battery pack become too high. Furthermore, temperature distribution of the battery pack can also be uneven which may influence the performance and service life of the battery pack. A particular working temperature is required, and overheating of the battery pack is dangerous. Therefore, heat dissipation from the battery pack is very important.

A common method employing air-cooling has advantages of simple structure and low cost, however, cooling speed of the air-cooled method is slow, the heat transfer coefficient of the method is also low. The distribution of temperature of the battery pack can be uneven when the battery pack is discharged at high rate or when the surrounding environment temperature is high. A liquid-cooled method has advantages of a high heat transfer coefficient, the speed of cooling of the battery pack is much quicker, and uneven temperature distribution is more easily controlled. Heat dissipation by a forced air-cooled method is better than the heat dissipation effect of the air-cooled method. However, the liquid-cooled and the forced air-cooled methods both require extra heat dissipation devices, such as fans, heat transfer device, and so on.

### SUMMARY

The present disclosure provides an electric vehicle, a heat-dissipating device adapted to the electric vehicle, and a method for dissipating heat from electric vehicle. The disclosure provides lower energy consumption and low cost, the disclosure is capable of simply and conveniently dissipating heat from a battery pack.

The present disclosure provides an electric vehicle including a battery pack and a heat dissipation device. The heat dissipation device is configured to dissipate heat generated by the battery pack. The heat dissipation device includes a heat dissipation member and one or more heat dissipation pipes. The one or more heat dissipation pipes are embedded in the heat dissipation member. The heat dissipation member and the battery pack are in direct contact with each other to form a heat transfer path.

The heat dissipation member transfers the heat generated by the battery pack to the one or more heat dissipation pipes.

A first end of the one or more heat dissipation pipes extends from the heat dissipation member to a body of the electric vehicle and forms a coolant inlet in the body of the electric vehicle. A second end of the one or more heat dissipation pipes extends from the heat dissipation member to the body of the electric vehicle and forms a coolant outlet in the body of the electric vehicle. The coolant inlet is configured to provide an entrance for the coolant to enter into the one or more heat dissipation pipes, and the coolant outlet is configured to provide an exit for the coolant to flow out from the one or more heat dissipation pipes.

The heat-dissipating device includes a coolant circulating pump and a tank. The tank is configured to store coolant. The coolant circulating pump is configured to engage with the coolant inlet of the one or more heat dissipation pipes of the electric vehicle and communicate with the one or more heat dissipation pipes. The coolant circulating pump is configured to inject the coolant in the tank into the one or more heat dissipation pipes via the coolant inlet of the electric vehicle, and drive the coolant to flow in the one or more heat dissipation pipes. The coolant circulating pump is further configured to remove the coolant from the one or more heat dissipation pipes via the coolant outlet of the electric vehicle. Thus, the heat collected by the heat dissipation member and the one or more heat dissipation pipes can be brought from the body of the electric vehicle.

A method for dissipating heat from electric vehicle is also disclosed. The method collects and transfers the heat generated by the battery pack of the electric vehicle to the one or more heat dissipation pipes of the electric vehicle via the heat dissipation member of the electric vehicle when the electric vehicle is being driven.

The coolant in the tank of the heat-dissipating device is injected into the one or more heat dissipation pipes via the coolant inlet of the electric vehicle by the coolant circulating pump of the heat-dissipating device. The coolant is drove to flow in the one or more heat dissipation pipes. And the coolant is removed from the one or more heat dissipation pipes via the coolant outlet of the electric vehicle. Thus, the heat generated by the battery pack of the electric vehicle can be brought from the body of the electric vehicle.

The method and device utilize phase change material (PCM) for their function. The generated heat of the battery pack is temporarily stored via the heat dissipation member and the one or more heat dissipation pipes when the electric vehicle is being driven and is disengaged from the external heat-dissipating device. Thus, when the electric vehicle stops being driven, for example when the battery pack of the electric vehicle is charged after depletion, and the electric vehicle engages with the external heat-dissipating device, the heat-dissipating device drives the coolant to flow in the one or more heat dissipation pipes. Thus, the coolant can bring the heat stored by the heat dissipation member and the one or more heat dissipation pipes together with heat generated by the battery being charged if the battery being charged when the coolant flows through the one or more heat dissipation pipes. Therefore, a cooling effect for the battery pack can be achieved. The present disclosure improves the liquid-cooled method by removing the cooling devices, for example, fans, heat transferring devices, and water cooling devices, and so on, from the electric vehicle and arranging for the cooling devices to be exterior to the body of the electric vehicle. Thus, the present disclosure couples to the heat-dissipating device only when the electric vehicle is charging. The weight of the vehicle itself reduces, and advantages of simplicity, convenience, low cost, and good heat dissipation are found. The PCM provides passive heat dissipation, the PCM consumes no power from the battery pack. Therefore, a mileage of the electric vehicle is optimized.

### BRIEF DESCRIPTION OF THE DRAWINGS

FIG. 1 illustrates a schematic view of an electric vehicle of a first embodiment.

FIG. 2 illustrates a cross-sectional view of a heat dissipation member of the electric vehicle of FIG. 1.

FIG. 3 illustrates a schematic view of a coolant inlet of the electric vehicle of FIG. 1.

FIG. 4 illustrates a heat-dissipating device coupled to the electric vehicle of FIG. 1.

FIG. 5 illustrates a flowchart of a method for dissipating heat from an electric vehicle.

FIG. 6 illustrates a schematic view of one embodiment of a battery pack and a heat dissipation of the electric vehicle of the first embodiment, being different from that in FIG. 1.

FIG. 7 illustrates a cross-sectional view taken along line VII-VII of FIG. 6.

FIG. 8 illustrates a schematic view of a battery pack and a heat dissipation device of another embodiment of the electric vehicle of the first embodiment, being different from that in FIG. 1.

FIG. 9 illustrates a cross-sectional view taken along line IX-IX of FIG. 8.

FIG. 10 illustrates a schematic view of an electric vehicle of a second embodiment.

FIG. 11 illustrates a schematic view of an electric vehicle of a third embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts can be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are connected permanently or releasably. The term “comprising” means “including, but not necessarily limited to”; it specifically indicates open-ended inclusion or membership in a so-described combination, group, series, and the like.

The present disclosure provides an electric vehicle. The electric vehicle includes a battery pack and a heat dissipation device. The heat dissipation device is configured to dissipate heat generated by the battery pack. The heat dissipation device includes a heat dissipation member and one or more heat dissipation pipes. The one or more heat dissipation pipes are embedded in the heat dissipation member. The heat dissipation member comprises PCM material. The heat dissipation member and the battery pack are in contact with each other to form a heat transfer path.

The heat dissipation member transfers the heat generated by the battery pack to the one or more heat dissipation pipes.

The one or more heat dissipation pipes contain the coolant. A first end of the one or more heat dissipation pipes extend from the heat dissipation member to a body of the electric vehicle and forms a coolant inlet in the body of the electric vehicle. A second end of the one or more heat dissipation pipes extend from the heat dissipation member to the body of the electric vehicle and forms a coolant outlet in the body of the electric vehicle, and vice versa. The coolant inlet is configured to provide an entrance for the coolant to enter into the one or more heat dissipation pipes, and the coolant outlet is configured to provide an exit for the coolant to flow out from the one or more heat dissipation pipes.

In one embodiment, the coolant is selected from at least one group consisting of phase change emulsion and water. The phase change emulsion is an even phase change emulsion formed by suspending the droplets of phase change material in single-phase heat transfer fluid (for example liquid water).

In one embodiment, the coolant is water.

In one embodiment, the present disclosure further includes one or more sealing members. The one or more sealing members are arranged on the coolant inlet, or arranged on the coolant outlet, or arranged on the coolant inlet and the coolant outlet. The manner of sealing employed by the one or more sealing members includes at least one selected from threaded seal, ferrule seal, and vacuum absorption seal. The one or more sealing members are configured to prevent a leakage of the coolant.

In one embodiment, the present disclosure further includes one or more one-way valves. The one-way valves are arranged in the coolant inlet and the coolant outlet. The one-way values are configured to prevent a backflow of the coolant.

In one embodiment, a horizontal position of the coolant inlet is lower than a horizontal position of the coolant outlet. The coolant can be completely removed from the one or more heat dissipation pipes after cooling the electric vehicle, safety risks of any leakage of the coolant remaining in the one or more heat dissipation pipes are thus avoided when the electric vehicle operates.

In one embodiment, the body of the electric vehicle defines a receiving hole. The receiving hole is configured to accommodate the coolant outlet.

In one embodiment, the present disclosure further includes a procedure control switch. The procedure control switch is arranged at a position of the coolant inlet. The procedure control switch is configured to detect a temperature of the coolant flowing into the one or more heat dissipation pipes, and control a flow rate of the coolant entering into the one or more heat dissipation pipes via the coolant inlet according to the detected temperature of the coolant.

In one embodiment, the present disclosure further includes one or more protection sleeves selected from a group consisting of a dustproof protection sleeve and a waterproof protection sleeve. The one or more protection sleeves are arranged at the coolant inlet and the coolant outlet.

In one embodiment, the battery pack is arranged at a front or at a rear of the electric vehicle.

In one embodiment, the heat dissipation member can be arranged on a top of the battery pack or a bottom of the battery pack.

In one embodiment, a size of the heat dissipation member is the same as an area of the bottom of the battery pack or the top of the battery pack.

In one embodiment, the one or more heat dissipation pipes are embedded in the heat dissipation member in a maze network design, for example, a “Z”-shape, a “maze-like network”-shape, a “U”-shape, an “S”-shape, or the like. The arrangement increases a contact area between the one or more heat dissipation pipes and the heat dissipation member, thus the heat transfer effect can be improved.

In one embodiment, the one or more heat dissipation pipes are embedded in the heat dissipation member in a straight tubular shape, for example, entering from an end of the heat dissipation member and out from another end of the heat dissipation member. The arrangement can embed a number of heating dissipation pipes side-by-side, thus the heat dissipation effect can be improved.

In one embodiment, the battery pack includes a number of battery units. The heat dissipation member is arranged between the battery units. A specific volume of the heat dissipation member changes at a preset temperature or between a preset temperature range, namely the heat dissipation member changes phases at the preset temperature or between the preset temperature range. Thereby the heat dissipation member collects the heat generated by the battery pack and infills gaps between the battery units when the heat dissipation member is heated above the preset temperature. Thus the heat generated by the battery pack can be rapidly and evenly dispersed and local heating can be avoided, simultaneously, the gaps between the battery units can be effectively filled. The heat generated by the battery pack can be better collected and stored by the heat dissipation member and transferred to the one or more heat dissipation pipes.

A battery pack includes a number of battery units. The battery units are in parallel. The number of the battery units can be selected according to a requirement of the voltage; thus, a waste of the power source can be prevented.

In one embodiment, the heat dissipation member can be at least one of paraffin wax, expandable graphite, steanic acid, and compressed expanded graphite composite material. Preferably, the heat dissipation member includes expandable graphite and the phase change material. The expandable graphite includes pores. The phase change material is fused within the expandable graphite by heating above the preset temperature and is collected by the expandable graphite, thus the phase change material does not drop from the battery pack and the heat dissipation member is adhered to the battery pack.

In one embodiment, the heat dissipation member is a compressed expanded graphite composite material. The compressed expanded graphite composite material is well known in the art.

In one embodiment, the present disclosure further includes a metal foil. The metal foil wraps around the heat dissipation member and the battery pack. The metal foil includes aluminum foil, copper foil, or the like. The metal foil prevents the heat dissipation member from separating from the battery pack when the heat dissipation member is heated above the preset temperature.

In one embodiment, the present disclosure further includes a metal foil. The metal foil wraps the heat dissipation member.

In one embodiment, the material of the one or more heat dissipation pipes can be at least one selected from aluminum, aluminum alloy, copper, copper alloy, and stainless steel. The material of the one or more heat dissipation pipes is high conductivity of heat. The one or more heat dissipation pipes have an advantage of low weight, easy carrying, and high heat dissipation. The one or more heat dissipation pipes are beneficial to heat dissipation via high heat transfer material.

In one embodiment, a diameter of the one or more heat dissipation pipes is 5˜10 millimeters.

In one embodiment, the number of the one or more heat dissipation pipes is at least two. The at least two heat dissipation pipes are gathered to form the coolant inlet and the coolant outlet, and the at least two heat dissipation pipes share the coolant inlet and the coolant outlet. At least one heat dissipation pipe is embedded into the heat dissipation member arranged on the top of the battery pack, and the other heat dissipation pipes are embedded into the heat dissipation member arranged on the bottom of the battery pack.

The heat-dissipating device includes a coolant circulating pump and a tank. The coolant circulating pump is configured to engage with the one or more heat dissipation pipes of the electric vehicle and communicate with the one or more heat dissipation pipes. The coolant circulating pump is configured to inject the coolant in the tank into the one or more heat dissipation pipes via the coolant inlet, drive the coolant to flow in the one or more heat dissipation pipes, and take the coolant out from the one or more heat dissipation pipes via the coolant outlet. Thus, the heat generated by the battery pack is brought from the body of the electric vehicle. The heat-dissipating device for example can be arranged with a charge interface of the electric vehicle, thus the heat-dissipating device can conveniently infuse coolant into the electric vehicle when the electric vehicle is being charged.

In one embodiment, the coolant circulating pump and the procedure control switch cooperatively control a flow rate of the coolant flowing into the one or more heat dissipation pipes.

In one embodiment, the heat-dissipating device includes a coolant storage device. The coolant storage device is configured to engage with the coolant outlet of the one or more heat dissipation pipes and communicate with the one or more heat dissipation pipes. The coolant storage device is configured to store the coolant removed from the one or more heat dissipation pipes via the coolant outlet.

In one embodiment, the coolant circulating pump, or the coolant storage device, or the coolant circulating pump and the coolant storage device include one or more interfaces. Each interface is adapted to the sealing member arranged at the coolant inlet or adapted to the sealing member arranged at the coolant outlet, and is configured to couple the coolant inlet, or the coolant outlet, or the coolant inlet and the coolant outlet, and seal the coolant circulating pump. or the coolant storage device, or the coolant circulating pump and the coolant storage device.

The present disclosure further provides a method for dissipating heat from the electric vehicle. A phase change material is selected wherein a phase and a specific volume of the phase change material change at a preset temperature. A heat dissipation device comprising a heat dissipation member being in direct contact with a battery pack and one or more heat dissipation pipes embedded in the heat dissipation member are provided wherein the heat dissipation member includes the phase change material. The heat generated by the battery pack of the electric vehicle is collected and transferred to the one or more heat dissipation pipes of the electric vehicle via the heat dissipation member of the electric vehicle when the electric vehicle is being driven and disengaged from a heat-dissipating device.

By the method, coolant in the tank is injected into the one or more heat dissipation pipes via the coolant inlet of the electric vehicle by the coolant circulating pump of the heat-dissipating device. Further, the coolant is drove to flow in the one or more heat dissipation pipes, and the coolant is removed from the one or more heat dissipation pipes via the coolant outlet of the electric vehicle. Thus, the heat collected and stored by the heat dissipation member and the one or more heat dissipation pipes can be brought from the body of the electric vehicle.

### First Embodiment

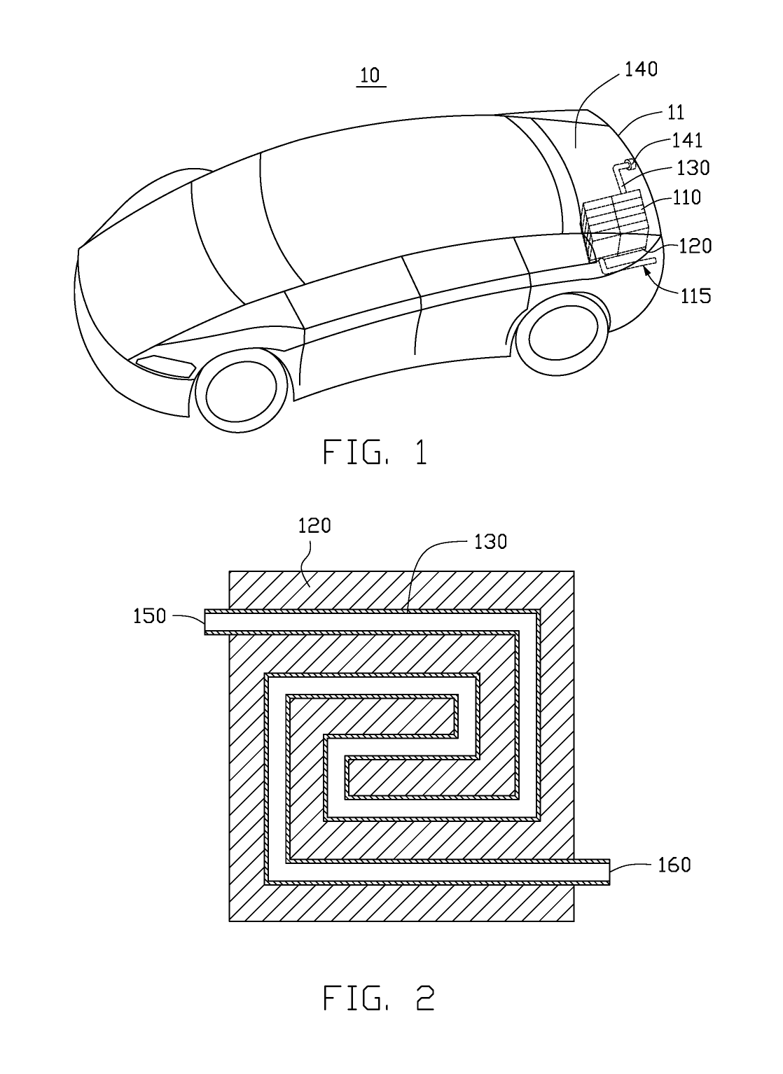

FIG. 1 illustrates an electric vehicle of a first embodiment. The electric vehicle 10 includes a battery pack 110 and a heat dissipation device. The battery pack 110 is arranged in the rear 11 of the electric vehicle 10. The heat dissipation device 115 is configured to dissipate the heat generated by the battery pack 110.

The heat dissipation device 115 includes a heat dissipation member 120 and a heat dissipation pipe 130. The heat dissipation member 120 is made of PCM material. The heat dissipation member 120 is adhered to the bottom of the battery pack 110. The heat dissipation member and the battery pack 110 are in contact with each other to form a heat transfer path. The heat dissipation member 120 dissipates heat passively and does not consume power of the battery pack 110. Therefore, a working mileage of the electric vehicle 10 is improved. The size of the heat dissipation member 120 is of a size appropriate for the bottom of the battery pack 110. Preferably, the heat dissipation member 120 is expandable graphite, and the size of the heat dissipation member is 283×274×10 millimeters. In other embodiments, the heat dissipation member 120 includes expandable graphite and the PCM material. The expandable graphite includes pores. The phase change material is fused by heating above the preset temperature, and is absorbed by the expandable graphite, thus the phase change material does not drop from the battery pack 110 and the heat dissipation member 120 is adhered to the battery pack 110.

Referring also to FIG. 2, the heat dissipation pipe 130 is embedded in an interior of the heat dissipation member 120 in a maze network shape. Thus, a contact area between the heat dissipation pipe 130 and the heat dissipation member 120 is increased, and a heat transfer effect is improved. In the embodiment, the heat dissipation pipe 130 is distributed in the heat dissipation member 120 in shape of a “maze-like network”. The heat dissipation pipe 130 is filled with the coolant. In the embodiment, the coolant is selected from at least one group consisting of phase change emulsion and water. The phase change emulsion is an even phase change emulsion formed by suspending the droplets of phase change material in single-phase heat transfer fluid (for example liquid water). In other embodiment, the coolant includes water. The heat dissipation member 120 transfers the heat generated by the battery pack 110 to the heat dissipation pipe 130. In the embodiment, the diameter of the heat dissipation pipe 130 is 5˜10 millimeters. The material of the heat dissipation pipe 130 has feature of high heat conductivity. The heat dissipation pipe 130 has advantages of low weight, easily carried, and high heat dissipation. The heat dissipation pipe 130 dissipates heat via high heat conductivity. In the embodiment, the diameter of the heat dissipation pipe 130 is 8 millimeters, and the material of the heat dissipation pipe 130 is aluminum.

A first end of the heat dissipation pipe 130 extends from the heat dissipation member 120 to a body 140 of the electric vehicle 10 and forms a coolant inlet 150 in the body 140 of the electric vehicle 10. A second end of the heat dissipation pipe 130 extends from the heat dissipation member 120 to the body 140 of the electric vehicle 10 and forms a coolant outlet 160 in the body 140 of the electric vehicle 10. The horizontal position of the coolant inlet 150 is lower than the horizontal position of the coolant outlet 160. In the embodiment, the coolant can be completely removed from the heat dissipation pipe 130 after cooling the electric vehicle 10, safety risks of any leakage of the coolant remaining in the heat dissipation pipe 130 are thus avoided when the electric vehicle 10 operates.

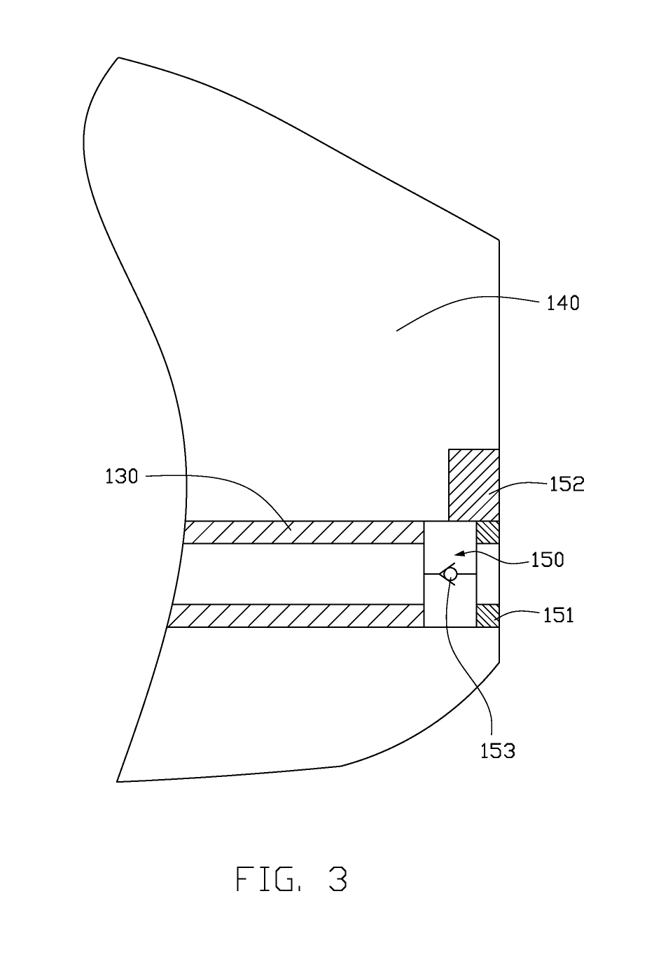

Referring also to FIG. 3, the electric vehicle 10 includes a number of sealing members 151. The sealing members 151 are arranged on the coolant inlet 150 and the coolant outlet 160. FIG. 3 only illustrates the sealing member 151 arranged on the coolant inlet 150. An arrangement of the sealing member 151 on the coolant outlet 160 is the same as the sealing member 151 being arranged on the coolant inlet 150, which is not shown in the figure. In the embodiment, the sealing manner of the sealing members 151 are ferrule seal. The sealing members 151 are configured to prevent a leakage of the coolant. In the embodiment, the electric vehicle 10 further includes a procedure control switch 152. The procedure control switch 152 is arranged at a position of the coolant inlet 150. The procedure control switch 152 is configured to detect a temperature of the coolant flowing into the heat dissipation pipe 130, and control a flow rate of the coolant entering into the heat dissipation pipe 130 via the coolant inlet according to the detected temperature of the coolant. The electric vehicle 10 further includes a number of one-way valves 153. An interior of the coolant inlet 150 and the coolant outlet 160 is each arranged with one one-way valve 153. Each one-way value 153 is configured to prevent a backflow of the coolant.

In one embodiment, the body 140 of the electric vehicle 10 defines a receiving hole 141. The receiving hole 141 accommodates the charge interface of the electric vehicle 10 and the coolant inlet 150. For example, the charge interface of the electric vehicle 10 and the coolant inlet 150 are arranged in parallel in a hole of the body 140 of the electric vehicle 10, thus the heat-dissipating device can conveniently infuse coolant into the electric vehicle 10 at the time when the electric vehicle 10 is being charged.

In one embodiment, the electric vehicle 10 further includes one or more protection sleeves selected from a group consisting of a dustproof protection sleeve and a waterproof protection sleeve. The coolant inlet 150 and the coolant outlet 160 each carries the protection sleeve.

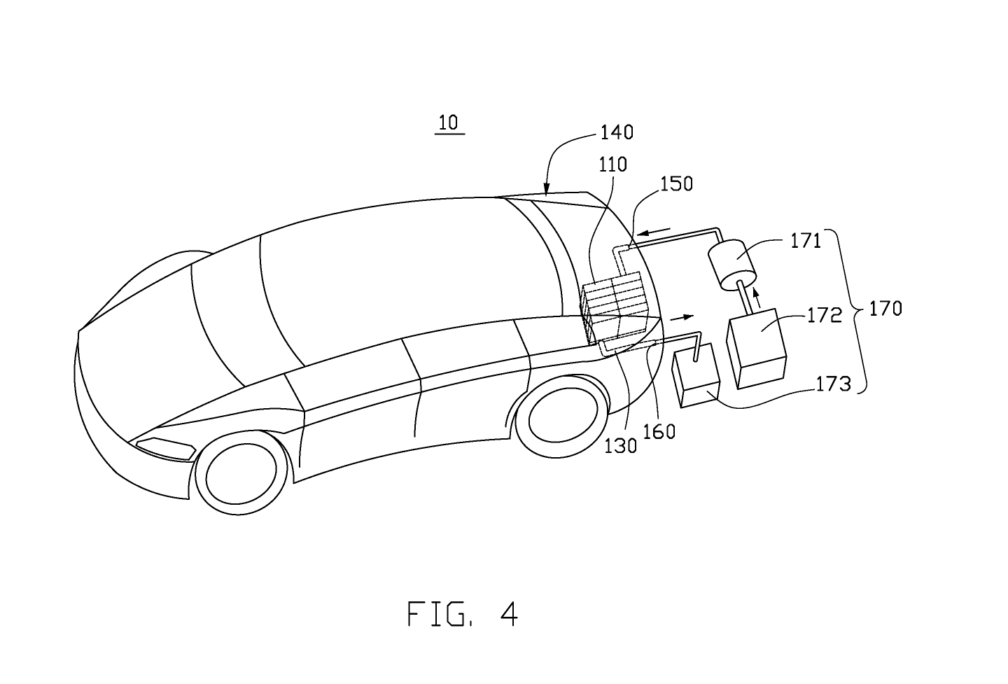

Referring also to FIG. 4, the heat-dissipating device 170 adapted to the electric vehicle 10 is provided. The heat-dissipating device 170 includes a coolant circulating pump 171, a water bank 172, and a coolant storage device 173. The coolant circulating pump 171 communicates with the coolant inlet 150 of the heat dissipation pipe 130. The water bank 172 is configured to store the coolant. The coolant storage device 173 communicates with the coolant outlet 160 of the heat dissipation pipe 130. The coolant circulating pump 171 and the coolant storage device 173 each includes the interface. The interface of the coolant circulating pump 171 engages with the sealing member 151 arranged at the coolant inlet 150, and the interface of the coolant storage device 173 engages with the sealing member 151 arranged at the coolant outlet 160, and vice versa. Thus, the coolant circulating pump 171 and the coolant storage device 173 each communicates with the heat dissipation pipe 130.

The coolant circulating pump 171 is engaged with the coolant inlet 150 of the heat dissipation pipe 130 via the interfaces and the sealing member 151 and the coolant storage device 173 is engaged with the coolant outlet 160 of the heat dissipation pipe 130 via the interface and the sealing member 151 when the electric vehicle 10 stops being driven and engages with the heat-dissipating device 170. After the coolant circulating pump 171 is started, the coolant circulating pump 171 injects coolant in the tank 172 into the heat dissipation pipe 130 via the coolant inlet 150, drives the coolant to flow in the heat dissipation pipe 130, and takes out the coolant from the heat dissipation pipe 130 via the coolant outlet of the electric vehicle 10. Thus, the heat generated by the battery pack 110 of the electric vehicle 10 can be brought from the body of the electric vehicle 10. In the embodiment, the coolant flows to the coolant storage device 173 to be recycled after being removed from the coolant outlet 160. Preferably, the flow rate of the coolant is 0.5 meters per second.

The heat-dissipating device 170 can be any device including a device pump capable of injecting coolant into the heat dissipation pipe 120, for example, the heat-dissipating device can be a faucet, or the like.

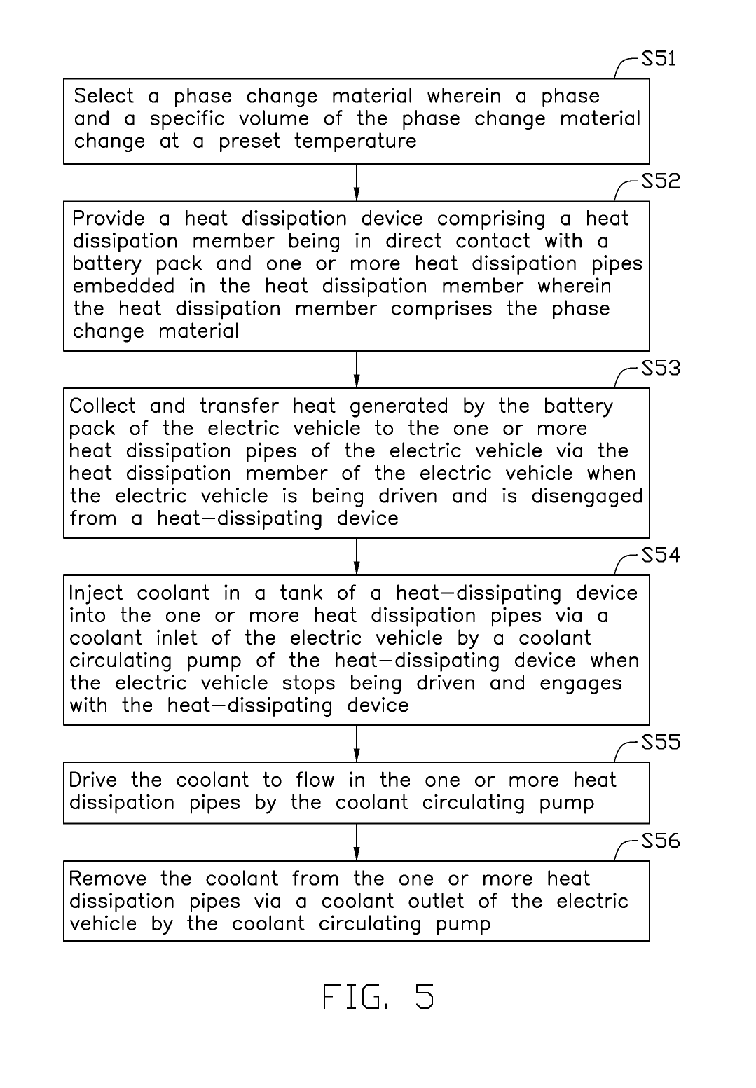

FIG. 5 illustrates a flowchart of a method for dissipating heat from electric vehicle. The illustrated order of blocks is illustrative only and the order of the blocks can be changed. Additional blocks can be added or fewer blocks can be utilized without departing from this disclosure. The method is applied in an electronic device. The electronic device can be any suitable electronic device, for example, a personal computer, a tablet computer, a mobile phone, a personal digital assistant (PDA), or the like. The example method can begin at block S51.

At block 51, select a phase change material wherein a phase and a specific volume of the phase change material change at a preset temperature.

At block 52, provide a heat dissipation device comprising a heat dissipation member being in direct contact with a battery pack and one or more heat dissipation pipes embedded in the heat dissipation member wherein the heat dissipation member comprises the phase change material.

At block 53, collect and transfer heat generated by the battery pack of the electric vehicle to the one or more heat dissipation pipes of the electric vehicle via the heat dissipation member of the electric vehicle when the electric vehicle is being driven and is disengaged from a heat-dissipating device.

At block 54, inject coolant in a tank of a heat-dissipating device into the one or more heat dissipation pipes via a coolant inlet of the electric vehicle by a coolant circulating pump of the heat-dissipating device when the electric vehicle stops being driven and engages with the heat-dissipating device.

At block 55, drive the coolant to flow in the one or more heat dissipation pipes by the coolant circulating pump of the heat-dissipating device.

At block 56, remove the coolant from the one or more heat dissipation pipes via a coolant outlet of the electric vehicle by the coolant circulating pump of the heat-dissipating device.

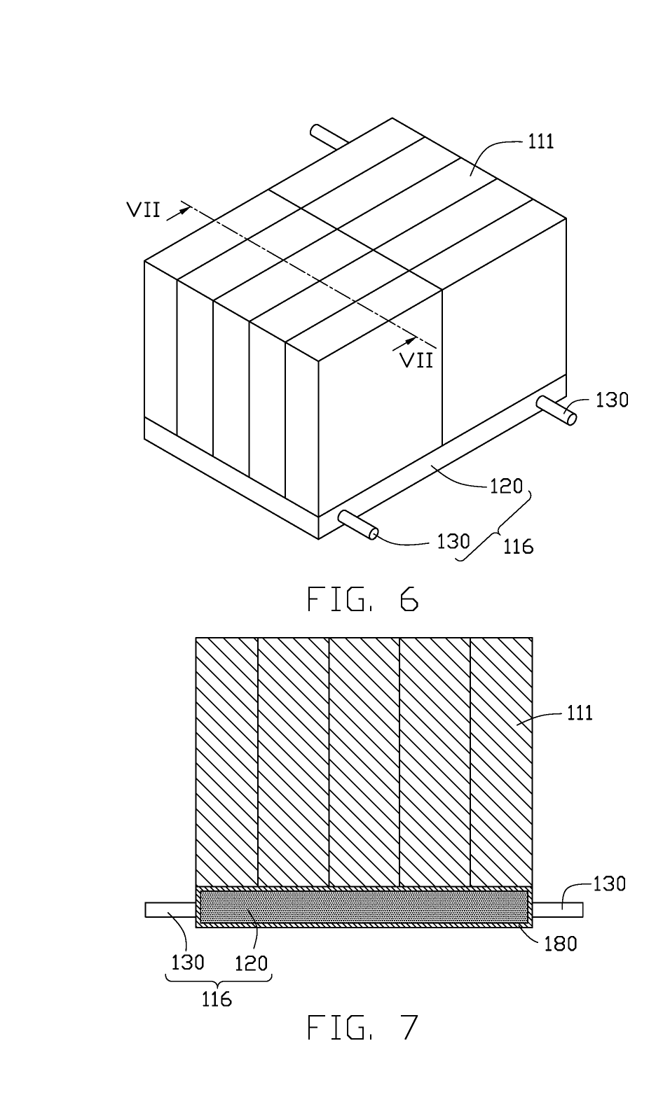

FIG. 6 illustrates a battery pack and a heat dissipation device of one embodiment of the electric vehicle different from that in FIG. 1. The battery pack 111 and the heat dissipation device 116 of FIG. 6 are similar to the battery pack 110 and the heat dissipation device 115 of FIG. 1. The heat dissipation device 116 also includes the heat dissipation member 120 and the heat dissipation pipe 130. The difference between the battery pack 111 and the heat dissipation device 116 of FIG. 6 and the battery pack 110 and the heat dissipation device 115 of FIG. 1 are described below.

In the embodiment, there are at least two heat dissipation pipes 130. The at least two heat dissipation pipes 130 are embedded in the heat dissipation member 120. The heat dissipation pipes 130 are arranged in the heat dissipation member 120 side-by-side in a straight tubular shape. Thus, a number of heat dissipation pipes 130 can be embedded in the heat dissipation member 120 side-by-side. A heat dissipation effect can be improved. Two ends of the at least two heat dissipation pipes 130 extend from the heat dissipation member 120 to the body of the electric vehicle, gathering together to form the coolant inlet and the coolant outlet. In other embodiment, one heat dissipation pipe is employed in the present disclosure. The heat dissipation pipe 130 is distributed in the heat dissipation member 120 in shape of an “S”.

Referring to FIG. 7, the heat dissipation device further includes a metal foil 180. The metal foil 180 wraps the heat dissipation member 120. The metal foil 180 is configured to prevent the heat dissipation member 120 from separating from the battery pack 111 when the heat dissipation member 120 is heated over the preset temperature. In the embodiment, the material of the metal foil 180 is aluminum and the heat dissipation member 120 is paraffin wax.

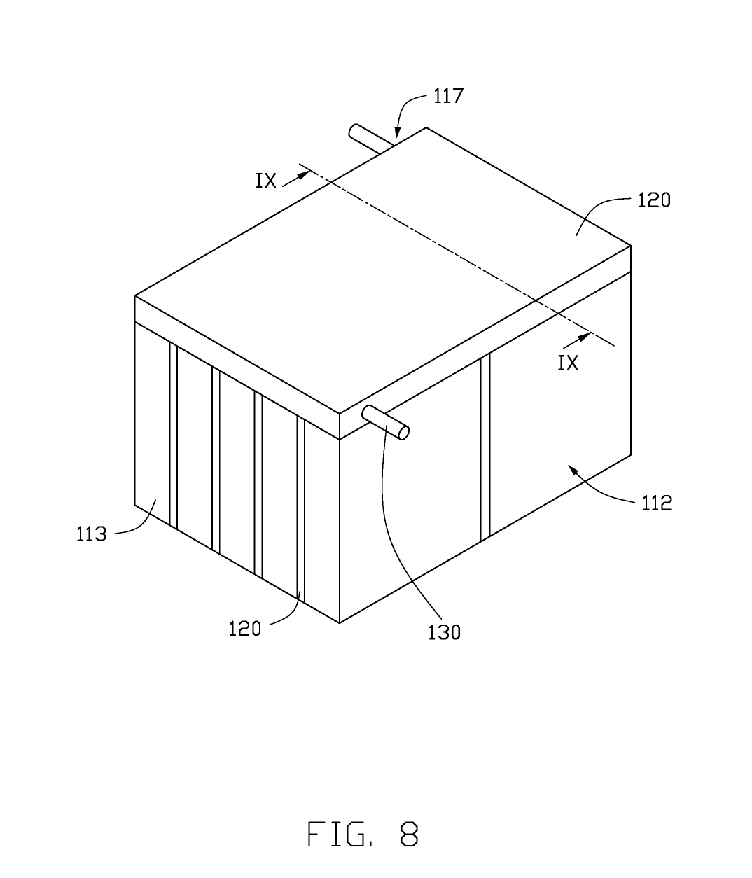

FIG. 8 illustrates a battery pack and a heat dissipation device of another embodiment of the electric vehicle, different from that of FIG. 1. The battery pack 112 and the heat dissipation device 117 of FIG. 8 are similar to the battery pack 110 and the heat dissipation device 115 of FIG. 1. The heat dissipation device 117 also includes the heat dissipation member 120 and the heat dissipation pipe 130. The difference between the battery pack 112 and the heat dissipation device 117 of FIG. 8 and the battery pack 110 and the heat dissipation device 115 of FIG. 1 are described below.

The heat dissipation member 120 is adhered on the top of the battery pack 112. The heat dissipation pipe 130 is distributed in the heat dissipation member 120 in shape of a “Z”. In other embodiment, there are at least two heat dissipation pipes 130. The at least two heat dissipation pipes 130 are embedded in the heat dissipation member 120. The heat dissipation pipes 130 are arranged in the heat dissipation member 120 side-by-side in a straight tubular shape. Two ends of the at least two heat dissipation pipes 130 extend from the heat dissipation member 120 to the body of the electric vehicle, gathering together to form the coolant inlet and the coolant outlet. The battery pack 112 includes a number of battery units 113. The battery units 113 are in parallel. The number of the battery units 113 can be selected according to a requirement of the voltage, thus a waste of the power source can be prevented. The heat dissipation member 120 is arranged in the gaps between the battery units 113 of the battery pack 112. A specific volume of the heat dissipation member 120 changes at the preset temperature or between the preset temperature range, namely the heat dissipation member 120 changes phases at a preset temperature or between the preset temperature range. Thereby the heat dissipation member 120 collects the heat generated by the battery pack 112 and infills gaps between the battery units 113 when the heat dissipation member 120 is heated above the preset temperature. Thus the heat generated by the battery pack 112 can be rapidly dispersed evenly and a local heating can be avoided. Simultaneously, the gap between the battery units 113 can be effectively filled. The heat generated by the battery pack 112 can be better collected and stored by the heat dissipation member 120 and transferred to the heat dissipation pipe 130.

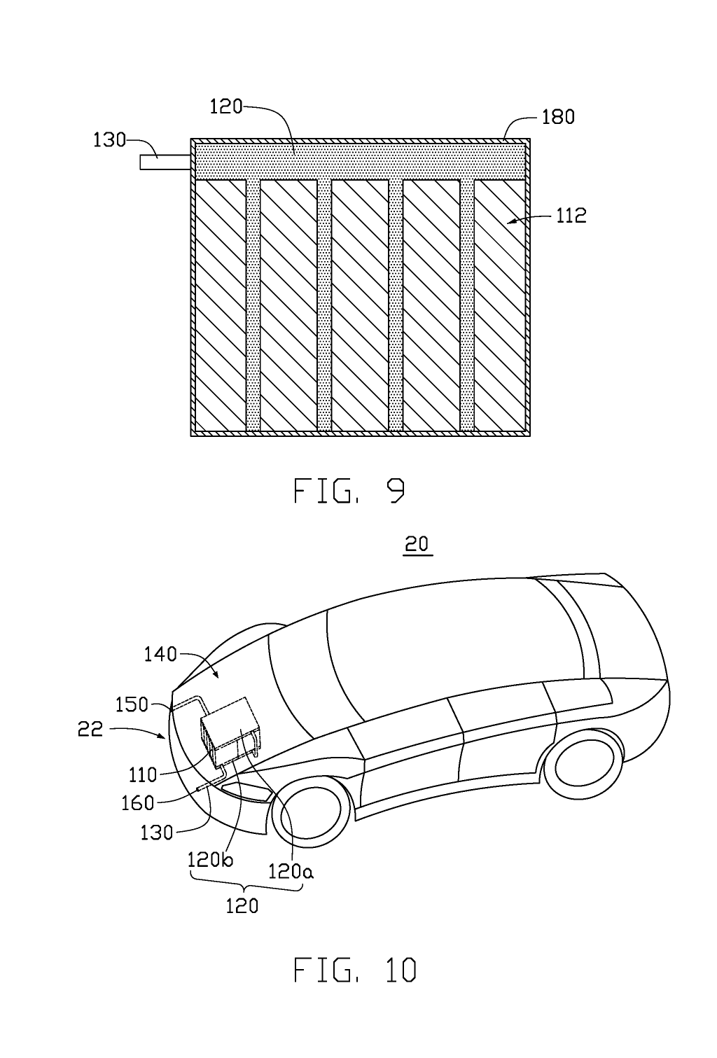

Referring to FIG. 9, the heat dissipation device 117 further includes a metal foil 180. The metal foil 180 wraps around the heat dissipation member 120 and the battery pack 112. The metal foil 180 is configured to prevent the heat dissipation member 120 from separating from the battery pack 112 when the heat dissipation member 120 is heated over the preset temperature. In the embodiment, the material of the metal foil 180 is copper and the heat dissipation member 120 is stearic acid.

### Second Embodiment

FIG. 10 illustrates an electric vehicle of a second embodiment. The electric vehicle of FIG. 10 is similar to the electric vehicle of FIG. 1. The difference between the electric vehicle 20 of FIG. 10 and the electric vehicle 10 of FIG. 1 are described below.

The battery pack 10 is arranged in a front 22 of the electric vehicle 20. The heat dissipation member 120 includes a first heat dissipation member 120a and a second heat dissipation member 120b. The first heat dissipation member 120a is adhered to the top of the battery pack 110 and the second heat dissipation member 120b is adhered to the bottom of the battery pack 110. The heat dissipation pipe 130 is embedded in the first heat dissipation member 120a and the second heat dissipation member 120b. In detail, the heat dissipation pipe 130 enters into the heat dissipation member 120a arranged on the top of the battery pack 110 and is distributed in the heat dissipation member 120a in shape of an “S”. The heat dissipation pipe 130 then leaves from the heat dissipation member 120a, and extends along a side of the battery pack 110 to the heat dissipation member 120b arranged on the bottom of the battery pack 110 and is distributed in the heat dissipation member 120b in shape of an “S”. Two ends of the heat dissipation pipe 130 extend to the body of the electric vehicle 20 from the heat dissipation member 120a and 120b to form the coolant inlet and the coolant outlet. In the embodiment, the diameter of the heat dissipation pipe 130 is 5 millimeters, and the material of the heat dissipation pipe 130 is copper. In the embodiment, the heat dissipation member 120 is compressed expanded graphite composite material. The compressed expanded graphite composite material is well known in the art.

### Third Embodiment

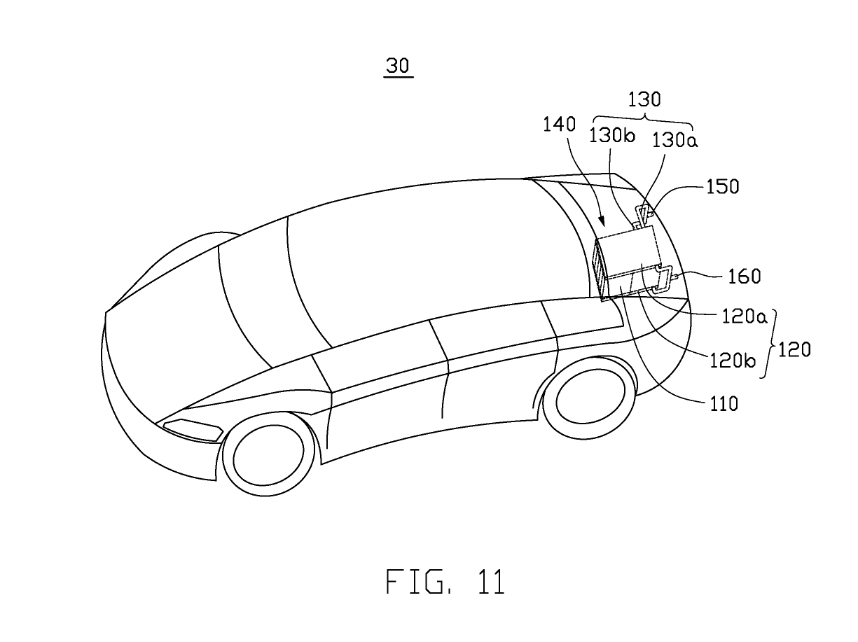

FIG. 11 illustrates an electric vehicle of a third embodiment. The electric vehicle of FIG. 11 is similar to the electric vehicle of FIG. 1. The difference between the electric vehicle 30 of FIG. 11 and the electric vehicle 10 of FIG. 1 are described below.

The heat dissipation member 120 includes a first heat dissipation member 120a and a second heat dissipation member 120b. The first heat dissipation member 120a is adhered to the top of the battery pack 110 and the second heat dissipation member 120b is adhered to the bottom of the battery pack 110. There are two heat dissipation pipes 130, a first heat dissipation pipe 130a and a second heat dissipation pipe 130b. The first heat dissipation pipe 130a is embedded into the first heat dissipation member 120a and the second heat dissipation pipe 130b is embedded into the second heat dissipation member 120b. The first heat dissipation pipe 130a is distributed in the first heat dissipation member 120a in a straight tubular shape, and the second heat dissipation pipe 130b is distributed in the second heat dissipation member 120b in a straight tubular shape. A first end of the first heat dissipation pipe 130a extends from the first heat dissipation member 120a to the body 140 of the electric vehicle 30 and a first end of the second heat dissipation pipe 130b extends from the second heat dissipation member 120b to the body 140 of the electric vehicle 30, gathering together to form the coolant inlet 150. A second end of the first heat dissipation pipe 130a extends from the first heat dissipation member 120a to the body of the electric vehicle and a second end of the second heat dissipation pipe 130b extends from the second heat dissipation member 120b to the body of the electric vehicle, gathering together to form the coolant outlet 160. In the embodiment, the diameter of the heat dissipation pipe 130 is 10 millimeters, and the material of the heat dissipation pipe is aluminum alloy. In the embodiment, the heat dissipation member 120 is made of a compressed expanded graphite composite material.

The structures of the different embodiments of the present disclosure can be combined into one embodiment, and are not limited by the details of the foregoing exemplary embodiments. Without departing from the spirit and the basic features of the present disclosure, the present disclosure can be implemented in other forms. For example, the heat dissipation pipe can be distributed in the heat dissipation member in shape of a “U”. For example, the material of the heat dissipation pipe is made of copper alloy or stainless steel.

It should be noted that, the above embodiments are merely to illustrate the technical solutions of the present disclosure, it is not intended to be limited, although the preferred examples with reference to the present disclosure have been described in detail, the person skilled in the art should be understood that the present disclosure may be modification or equivalent replacement, without departing from the spirit and scope of the present disclosure.

What is claimed is:

1. An electric vehicle comprising:
a battery pack; and
a heat dissipation device configured to dissipate heat generated by the battery pack, the heat dissipation device comprising:
a heat dissipation member comprising phase change material, the heat dissipation member being in direct contact with the battery pack to form a heat transfer path; and
one or more heat dissipation pipes embedded in the heat dissipation member;
wherein the heat dissipation member is configured to transfer the heat generated by the battery pack to the one or more heat dissipation pipes;
wherein the heat dissipation member and the one or more heat dissipation pipes store the heat generated by the battery pack when the electric vehicle is being driven and disengaged from an external heat-dissipating device;
wherein the one or more heat dissipation pipes are configured to contain coolant, the heat dissipation member and the one or more heat dissipation pipes are configured to be took away heat stored therein via the coolant circulating in the one or more heat dissipation pipes by the external heat-dissipating device when the electric vehicle stops being driven and engages with the external heat-dissipating device;
wherein a first end of the one or more heat dissipation pipes extends from the heat dissipation member to a body of the electric vehicle and forms a coolant inlet in the body of the electric vehicle, and a second end of the one or more heat dissipation pipes extends from the heat dissipation member to the body of the electric vehicle and forms a coolant outlet in the body of the electric vehicle;
wherein the coolant inlet is configured to provide an entrance for the coolant to enter into the one or more heat dissipation pipes, and the coolant outlet is configured to provide an exit for the coolant to flow out from the one or more heat dissipation pipes.

2. The electric vehicle of claim 1, further comprising one or more sealing members, wherein the one or more sealing members are arranged on the coolant inlet, or arranged on the coolant outlet, or arranged on the coolant inlet and the coolant outlet, the manner of sealing employed by the one or more sealing members comprises at least one selected from threaded seal, ferrule seal, and vacuum absorption seal.

3. The electric vehicle of claim 1, further comprising one or more one-way valves, wherein:
the one-way valves are arranged in the coolant inlet and the coolant outlet, the one-way values are configured to prevent a backflow of the coolant.

4. The electric vehicle of claim 1, wherein a horizontal position of the coolant inlet is lower than a horizontal position of the coolant outlet.

5. The electric vehicle of claim 1, wherein the electric vehicle defines a receiving hole, the receiving hole is configured to accommodate the coolant outlet and a charge interface of the electric vehicle.

6. The electric vehicle of claim 1, further comprising a procedure control switch, wherein:
the procedure control switch is arranged at a position of the coolant inlet, the procedure control switch is configured to detect a temperature of the coolant flowing into the one or more heat dissipation pipes, and control a flow rate of the coolant entering into the one or more heat dissipation pipes via the coolant inlet according to the detected temperature of the coolant.

7. The electric vehicle of claim 1, wherein:
the number of the one or more heat dissipation pipes is at least two, the at least two heat dissipation pipes are gathered to form the coolant inlet and the coolant outlet, and the at least two heat dissipation pipes share the coolant inlet and the coolant outlet.

8. The electric vehicle of claim 7, wherein:
the at least two heat dissipation pipes are distributed in the heat dissipation member in a straight tubular shape.

9. The electric vehicle of claim 7, wherein:
the heat dissipation member comprises a first heat dissipation member and a second heat dissipation member, the first heat dissipation member is adhered to a top of the battery pack, and the second heat dissipation member is adhered to a bottom of the battery pack, at least one of the at least two heat dissipation pipes is embedded in the first heat dissipation member and the other heat dissipation pipes of the at least two heat dissipation pipes are embedded in the second heat dissipation member.

10. The electric vehicle of claim 1, wherein:
the battery pack comprises a plurality of battery units, the heat dissipation member is arranged between the battery units, the heat dissipation member changes phases at a preset temperature or between a preset temperature range thereby collecting the heat generated by the battery pack and infilling gaps between the battery units when the heat dissipation member is heated above the preset temperature.

11. The electric vehicle of claim 1, wherein:
the heat dissipation member further comprises expandable graphite and the phase change material, the expandable graphite comprises pores, the phase change material is fused within the expandable graphite by heating above the preset temperature and is absorbed by the expandable graphite, preventing the phase change material dropping from the battery pack, the heat dissipation member is adhered to the battery pack.

12. The electric vehicle of claim 1, further comprising a metal foil, wherein:
the metal foil wraps around the heat dissipation member and the battery pack, the metal foil is configured to prevent the heat dissipation member from separating from the battery pack when the heat dissipation member is heated.

13. The electric vehicle of claim 1, further comprising one or more protection sleeves, wherein:
the one or more protection sleeves are arranged at the coolant inlet and the coolant outlet.

14. The electric vehicle of claim 1, wherein:
the heat dissipation pipe is distributed in the heat dissipation member in a maze network design.

15. The electric vehicle of claim 1, wherein:
the battery pack is arranged at a front of the electric vehicle or at a rear of the electric vehicle.

16. A heat-dissipating device comprising:
a coolant circulating pump, the coolant circulating pump being configured to engage with one or more heat dissipation pipes of an electric vehicle and communicate with the one or more heat dissipation pipes when the heat-dissipating device engages with the electric vehicle; and
a tank configured to contain coolant;
wherein the coolant circulating pump is configured to inject the coolant in the tank into the one or more heat dissipation pipes via the coolant inlet, drive the coolant to flow in the one or more heat dissipation pipes, and remove the coolant from the one or more heat dissipation pipes via the coolant outlet, thereby removing heat generated by the battery pack from the body of the electric vehicle.

17. The heat-dissipating device of claim 16, wherein:
the coolant circulating pump is configured to control a flow rate of the coolant entering into the one or more heat dissipation pipes.

18. The heat-dissipating device of claim 16, the heat-dissipating device further comprising a coolant storage device, wherein:
the coolant storage device is configured to engage with the coolant outlet of the one or more heat dissipation pipes and communicate with the one or more heat dissipation pipes, the coolant storage device is further configured to store the coolant removed from the one or more heat dissipation pipes via the coolant outlet.

19. A method for dissipating heat from electric vehicle comprising:
selecting a phase change material wherein a phase and a specific volume of the phase change material change at a preset temperature;
providing a heat dissipation device comprising a heat dissipation member being in direct contact with a battery pack and one or more heat dissipation pipes embedded in the heat dissipating member wherein the heat dissipation member comprises the phase change material;
collecting and transferring heat generated by the battery pack of the electric vehicle to the one or more heat dissipation pipes of the electric vehicle via the heat dissipation member of the electric vehicle when the electric vehicle is being driven and disengaged from a heat-dissipating device; and
injecting coolant in a tank of the heat-dissipating device into the one or more heat dissipation pipes via a coolant inlet of the electric vehicle by a coolant circulating pump of the heat-dissipating device when the electric vehicle stops being driven and engages with the heat-dissipating device;
driving the coolant to flow in the one or more heat dissipation pipes by the coolant circulating pump of the heat-dissipating device; and
removing the coolant from the one or more heat dissipation pipes via a coolant outlet of the electric vehicle by the coolant circulating pump of the heat-dissipating device, thereby removing the heat collected and stored by the heat dissipation member and the one or more heat dissipation pipes from a body of the electric vehicle.

20. The method for dissipating heat from the electric vehicle of claim 19, wherein:
the coolant is at least one selected from phase change emulsion and water.
